(19) United States
(12) Patent Application Publication
(10) Pub. No.: US 2015/0136631 A1
(43) Pub. Date: May 21, 2015

(54) OVERLAPPING WRAP-AROUND LABEL FOR ADHESIVELY ATTACHING AROUND THE CIRCUMFERENCE OF AN ARTICLE

(71) Applicant: Schreiner Group GmbH & Co. KG, Oberschleissheim (DE)

(72) Inventor: Peter Seidl, Muenchen (DE)

(73) Assignee: Schreiner Group GmbH & Co. KG, Oberschleissheim (DE)

(21) Appl. No.: 14/402,720

(22) PCT Filed: May 22, 2013
(86) PCT No.: PCT/EP2013/060507

§ 371 Date: Nov. 21, 2014

(30) Foreign Application Priority Data
May 23, 2012 (DE) 10 2012 104 460.0

(51) Int. Cl. G09F 3/02; B65C 9/00; A61J 1/00; B65C 3/08

(52) U.S. Cl. CPC G09F 3/02; B65C 3/08; B65C 9/0006; A61J 1/00; G09F 2003/0272
USPC 206/459.5; 156/249; 428/189

(57) ABSTRACT

An overlapping wrap-around label for adhesively attaching around the circumference of an article has a first indicator component and a second indicator component, which by being brought into contact with one another form an indicator arrangement. The first indicator component is arranged in a first portion of the area of the overlapping wrap-around label and the second indicator component is arranged in a second portion of the area of the overlapping wrap-around label. The second portion is offset from the first portion along a first direction and is thereby arranged separately from the first indicator component.

The invention relates to an overlapping wrap-around label for adhesively attaching around the circumference of an article. Overlapping wrap-around labels are those labels that are designed for wrapping around and/or adhesively attaching around the circumference of an article more than completely, and thereby overlap on themselves. In this connection, after a first end of the overlapping wrap-around label is set onto or pressed onto the circumference surface of the article, for example, and the overlapping wrap-around label has passed around and been adhesively attached to the circumference surface in the circumference direction, the second, opposite end of the overlapping wrap-around label finally comes to lie on the first end, so that the overlapping wrap-around label overlaps with itself. Containers for medications or pharmaceutical products, but also for liquids or foods are often provided with an overlapping wrap-around label. In medicine, for example, syringes and ampoules (vials) provided with an overlapping wrap-around label are in use for vaccines and other medications.

For such articles and other articles to be labeled, particularly in medicine, pharmacy or the foods industry, it is desirable to be able to evaluate the condition, quality, and suitability of a container content for the intended purpose, in each instance, in simple manner, for example in order to check whether and, if applicable, how long a medication or food has been exposed to a temperature that was higher than permissible. An interruption in the cooling chain during production, shipping or storage, up to when the container is opened for the first time or used, could be determined, for example, by means of an indicator material that discolors irreversibly as the result of an impermissibly high ambient temperature. Such an indicator can also be integrated into a label with which the container is provided.

In this connection, it would be disadvantageous that the label provided with the indicator can already be damaged during its production, shipping or subsequent storage, as the result of temperature variations, even before it is affixed to the article to be labeled, unless special counter-measures are taken. Changes in the indicator integrated into the label can also occur as the result of the process of dispensing the label onto the article, for example due to the effect of temperature or pressure. Then, the indicator would show that the temperature to which the label was exposed was overly high, but this would not hold true for the labeled article. The indicator is not allowed to be damaged, discolored or reduced in terms of its sensitivity as the result of dispensing of the label. Therefore, up to the present, production, storage, shipping, and application of the label had to be structured in very complicated manner, so that the indicator does not already react or loses its detection sensitivity, in part, even before the product is labeled. Therefore additional effort, in terms of work technology, has existed until now for the use of a label provided with an indicator. Furthermore, ultimately there is always some residual uncertainty as to how informative the indicator of the dispensed label actually is.

It is the task of the present invention to make available a label suitable for being adhesively attached around the circumference of an article, having an indicator that is suitable for detection of a temperature being exceeded, a temperature being fallen short of or of a critical change in another parameter, but is nevertheless non-sensitive to those variations in temperature or parameter that occur before or during dispensing of the label onto the circumference of the article. Furthermore, it is supposed to be possible to affix the label provided with the indicator to the article without any additional effort as compared with a label without an indicator, i.e. the label is supposed to have such a composition that no work steps occur when adhesively attaching the label to the circumference surface of the article that would not also occur when using a label without an indicator. Furthermore, an article, particularly a container, provided with a label is supposed to be made available, the label of which has an indicator for which it is reliably known that it is sensitive for detection of temperature or parameter changes only since labeling of the article, i.e. that it is free of prior damage due to production, storage or transport. Finally, a label arrangement suitable for forming such a label and a suitable method for labeling the circumference of an article are supposed to be made available.

This task is accomplished at first by means of an overlapping wrap-around label according to claim 1, wherein the overlapping wrap-around label has a first indicator component and a second indicator component that form an indicator arrangement by being brought into contact with one another, wherein the first indicator component is disposed in a first surface section of the basic surface of the overlapping wrap-around label and the second indicator component is disposed in a second surface section of the basic surface of the overlapping wrap-around label, and wherein the second surface section is offset, relative to the first surface section, along a first direction, and thereby disposed separately from the first indicator component.

The first direction along which two indicator components are disposed offset from one another is particularly a direction along which the contact surface between labels or the label underside and the article increases as the overlapping wrap-around label is adhesively attached around an article, before the entire or in any case the predominant label surface has been adhesively attached to and rolled onto the circumference surface. The direction of the offset between the two surface sections or indicator components relative to one another therefore corresponds to the roll-off direction or feed direction during the process of dispensing of the overlapping wrap-around label. After dispensing of the label has taken place, the first direction corresponds to the circumference direction of the article. With reference to the label surface, the first direction can particularly be a direction that runs parallel to the basic surface of the overlapping wrap-around label, i.e. runs in this direction. The two surface regions or indicator components of the protected overlapping wrap-around label are disposed offset relative to one another along the first direction, and thereby non-overlapping. Only once the label has been dispensed onto the circumference surface of an article does an overlap of the first and the second surface region relative to one another take place; specifically, this happens automatically during the dispensing process, when the label is wound around the circumference surface.

According to one embodiment, it is provided, for one thing, that the indicator is not present as a finished indicator material that is already sensitive for detection and thereby active, but rather in the form of two (chemically) different indicator components that are disposed in regions, particularly surface sections of the overlapping wrap-around label, spaced apart from one another, and only result in an indicator material that is sensitive for the temperature or the other parameter after they have been brought into contact with one another. Because the two components do not stand in contact with one another at first, they also do not react to a critical temperature being exceeded or fallen short of or to another parameter, at first; the overlapping wrap-around label is therefore not sensitive or inactive, at first, and can be processed, imprinted, shipped, and stored just like a label without an indicator.

The overlapping wrap-around label has such a composition that the two indicator components automatically come into contact with one another only when it is dispensed onto the circumference of an article. In this way, it is ensured that the indicator indicates only the changes in temperature or another parameter that act on the actual labeled article. In this way, in the case of a heat-sensitive product, for example, such as a medication, it is possible to determine more reliably than before whether and to what extent it was exposed to an overly high temperature, in terms of level and/or duration of effect, and therefore is no longer effective or only effective with restrictions. The label can also detect if other parameters have been critically exceeded, such as the intensity and the position of incident UV radiation, in more informative manner, because a change in the indicator before or during labeling of the article itself can be excluded. Furthermore, because of the spacing of the two indicator components, apart from one another, in the direction of the length of the overlapping wrap-around label, it is automatically ensured that the two indicator components automatically come into contact with one another when the overlapping wrap-around label is adhesively attached around the circumference surface of an article, and only then form the activated indicator, without any additional effort for this being required when the label is dispensed. The two indicator components can particularly be disposed at two opposite ends of the overlapping wrap-around label. Furthermore, the one component can be disposed on the top side, while the other component is disposed on the underside of the label. During adhesive attachment, the surface section predetermined by the second indicator component then overlaps with the surface section predetermined by the first indicator component at the opposite end of the label. In the delivered state, however, the overlapping wrap-around label does not yet overlap with itself, but rather does so only after it is dispensed onto the circumference surface of the article. In this way, it is ensured that the detection-sensitive, active indicator material is only formed by the chemical reaction of the two components with one another, as a result of the process of dispensing, which can be carried out in the same manner as in the case of an overlapping wrap-around label without an indicator. The proposed overlapping wrap-around label can be dispensed without additional effort as compared with labels without an indicator, so that no attention needs to be paid to the indicator any longer during production, storage, shipping, and application.

The task on which the invention is based is furthermore accomplished by an article according to claim 20 or 21, by a label arrangement according to claim 22, as well as by a method according to claim 26.

Some embodiments will be described as examples below, using the figures. These show:

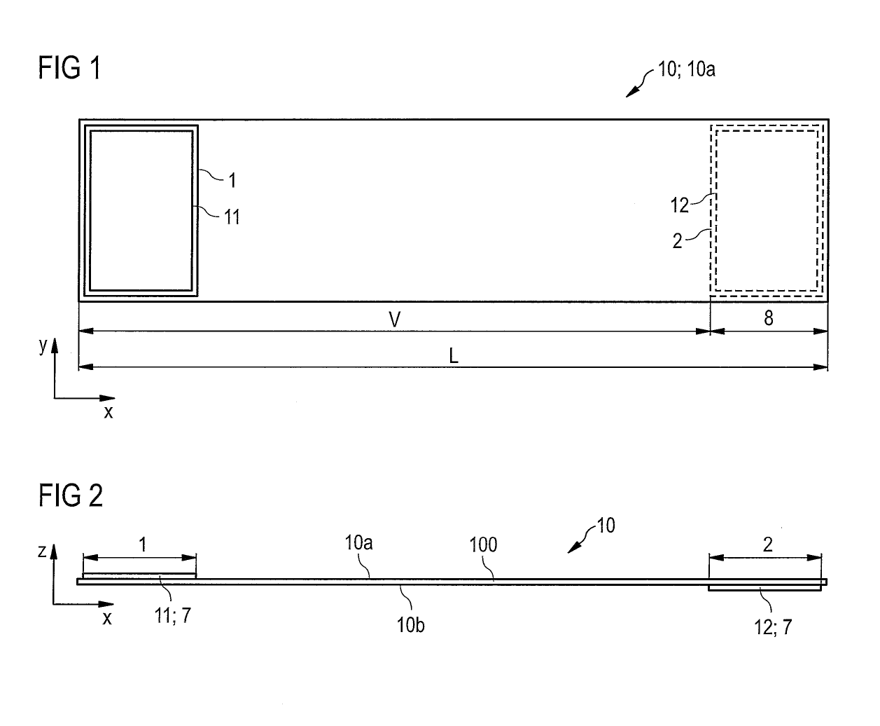

FIG. 1 a schematic top view of an exemplary overlapping wrap-around label,

FIGS. 2 to 5 different schematic cross-sectional views of different embodiments of the label from FIG. 1,

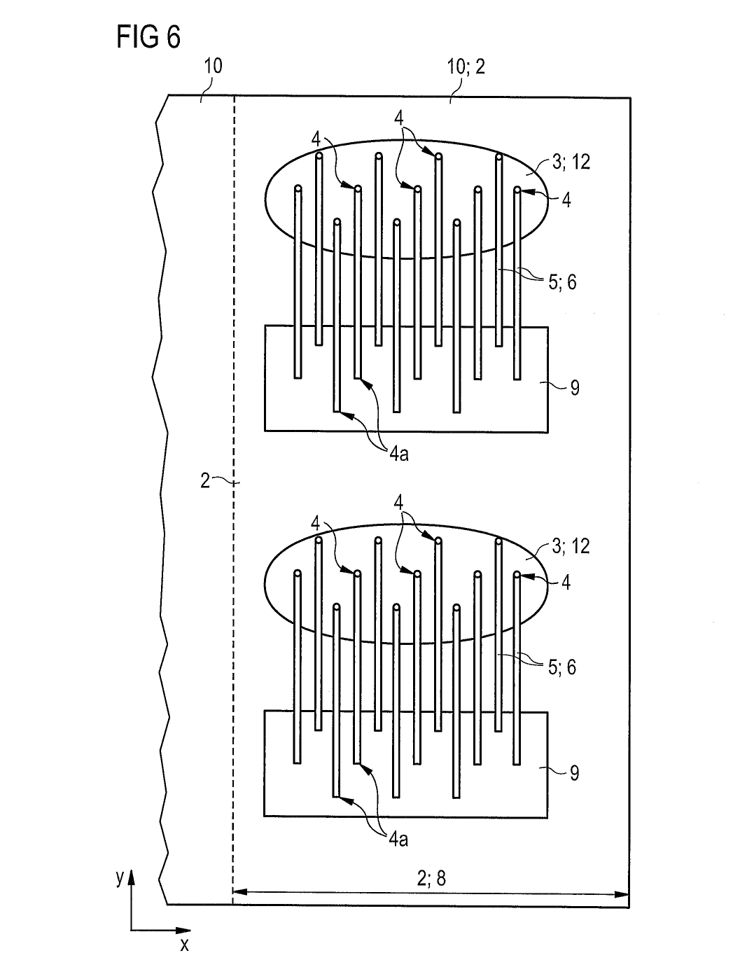

FIG. 6 a schematic partial view of a second surface section of an overlapping wrap-around label developed further as compared with FIG. 5,

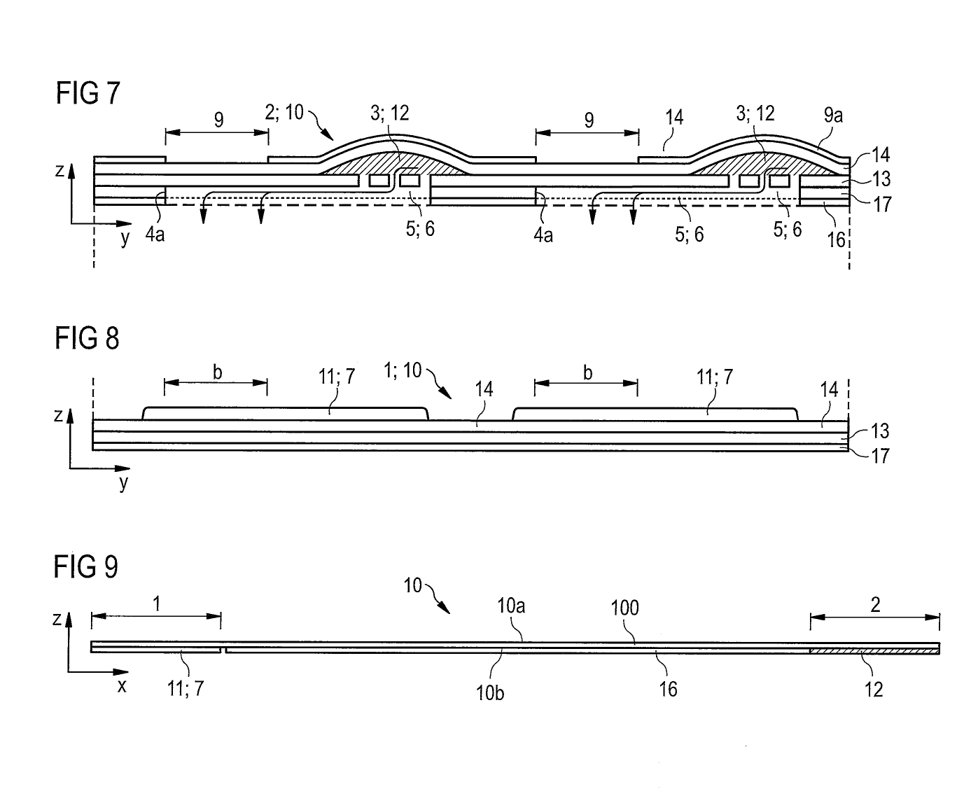

FIG. 7 a cross-sectional view of the second surface section of the label from FIG. 6,

FIG. 8 a corresponding cross-sectional view of the first surface section of the label of FIGS. 6 and 7,

FIG. 9 an alternative embodiment of an overlapping wrap-around label, as compared with FIG. 1,

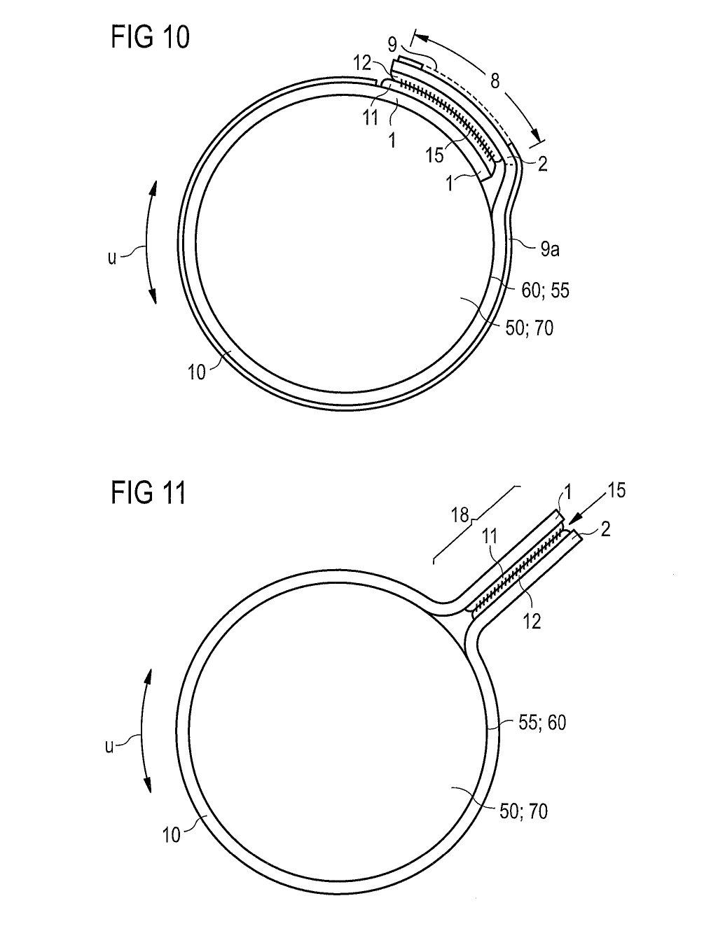

FIG. 10 a schematic cross-sectional view of an article, the circumference of which has an overlapping wrap-around label according to one of FIGS. 1 to 8 adhesively attached around it,

FIG. 11 a schematic cross-sectional view of an article, the circumference of which has an overlapping wrap-around label according to FIG. 9 adhesively attached around it,

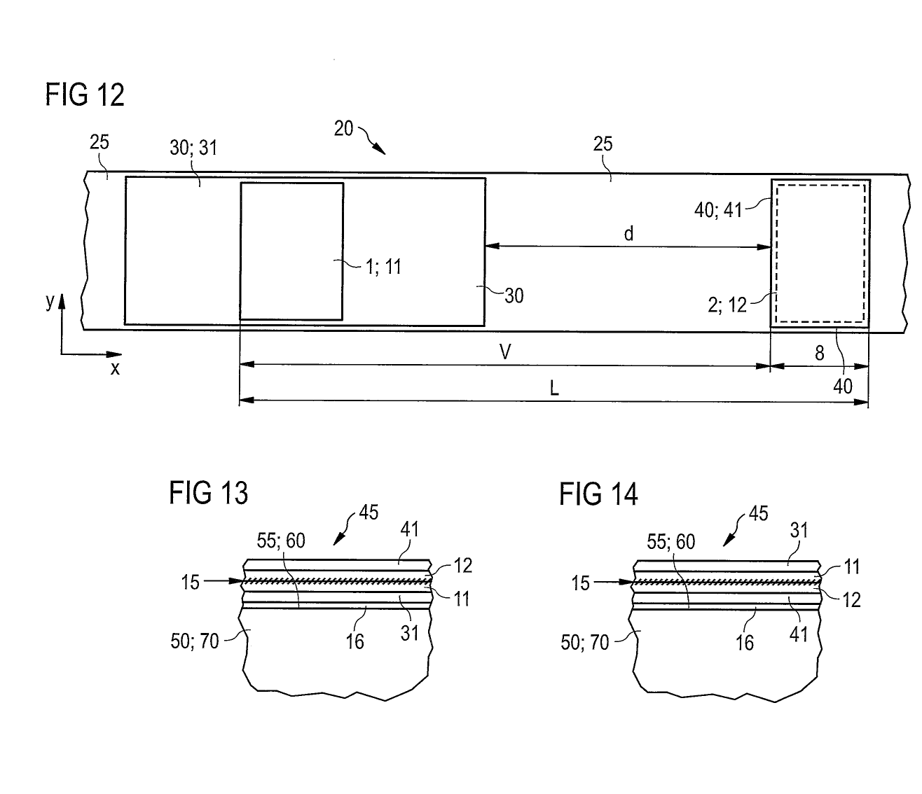

FIG. 12 a schematic top view of a label arrangement having two partial labels, each having an indicator component,

FIGS. 13 and 14 two partial views of a total label formed from two partial labels, in cross-section, through the overlapping region of the two partial labels,

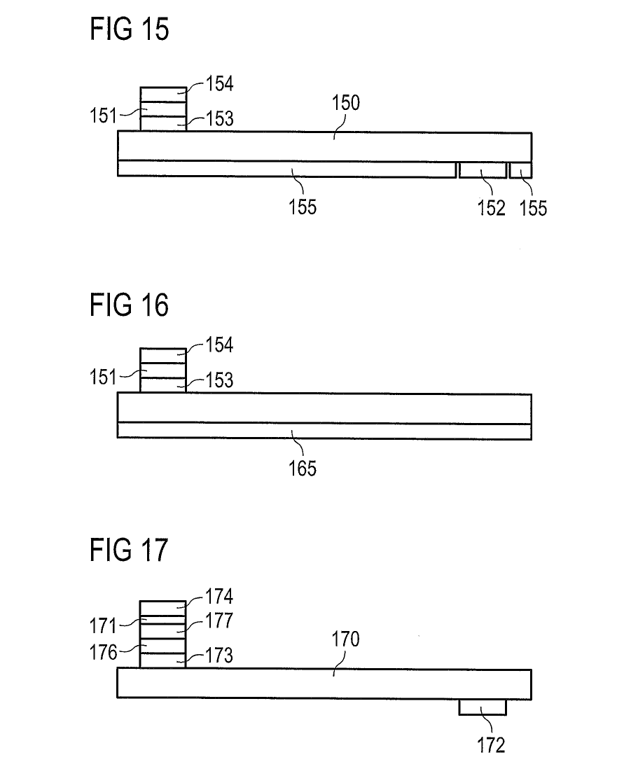

FIG. 15 a schematic cross-sectional view of a further embodiment of an overlapping wrap-around label,

FIG. 16 a schematic cross-sectional view of a modification of the further embodiment of FIG. 15, and

FIG. 17 a schematic cross-sectional view of a further modification of the further embodiment of FIG. 15.

FIG. 1 shows a top view of an embodiment of an overlapping wrap-around label 10 on the top side 10a. The label can be as an overlapping wrap-around label for an ampoule or vial for a liquid medication (for example a vaccine); such articles, which are in use worldwide, possess standardized dimensions that require labeling with correspondingly adapted dimensions; the same holds true for syringes for removing and/or injecting liquid medications or for taking blood samples. For the sake of brevity, reference will be made only to ampoules below, with regard to the labeled article. FIG. 1 shows an overlapping wrap-around label 10, the dimensions of which is adapted to the circumference of such an ampoule for liquid medications, for example; the label possesses a length L along a first direction x, which is greater than the circumference of a standardized ampoule (overlapping wrap-around label). At a first end of the overlapping wrap-around label 10 (on the left in FIG. 1), a first surface section 1 is disposed, which particularly corresponds to the dimensions of the applied first indicator component 11. This component is situated, according to FIG. 1, on the top side 10a, for example as an imprinted, pasty mass (paste) or as another coating. The first indicator component 11 in the first surface section 1 remains uncovered, i.e. exposed. At the opposite second end (on the right in FIG. 1), the second indicator component 12 is disposed in the second surface section 2; preferably on the underside (shown with a broken line). A lateral offset V exists between the two surface sections 1, 2 or the indicator components 11, 12, in each instance, which offset is as great as the standardized outside circumference of an ampoule vial (vial). The remaining label section, which is taken up by the second surface section 2, corresponds to an overlap region 8 of the label that occurs as soon as the overlapping wrap-around label 10 is adhesively attached to the ampoule circumference. In this connection, the second surface section 2 comes to lie on the first surface section 1, whereby the two indicator components 11, 12 come into contact with one another and thereby form the actual active or detection-sensitive indicator material 15 in the first place. The selection of the indicator components, in each instance, depends on the type of parameter to be detected and the amount of the critical limit value that must not be exceeded. For detection of a temperature that exceeds a permissible temperature to which a liquid medication, for example, is maximally allowed to be exposed, 2,2′-bipyridine is possible as the first indicator component and iron chloride is possible as the second indicator component, which, when brought into contact with one another, indicate temperatures above 8° C., for example, by means of a change in color. Alternatively, for detection of a prescribed minimum temperature that has been fallen short of, or a maximum temperature that has been exceeded, or of a value of another parameter that has been exceeded, such as, for example, the intensity of the effect of UV radiation, other pairs of components are also possible. Depending on the type of indicator components used, one could speak of an “activator” in the case of the first indicator component 11 and of the “actual” (but still inactive) indicator in the case of the second indicator component 12 (or vice versa). In each case, the finished, activated indicator material occurs only during adhesive attachment of the label around the circumference of the ampoule. As a result, no damage to the indicator or reduction of its sensitivity, of any kind, can occur during production, storage or shipping of the label, and dispensing of the label also does not cause the indicator to deteriorate, because it is only formed or activated, in the first place, during this process.

In the example of FIG. 1, the offset V corresponds to that partial length of the label that is required for a complete revolution of the label around the circumference surface of the article or container (here, the ampoule), so that the remaining length section, up to the total length L, is available as an overlap region 8 for forming the active indicator material. The second indicator component 12, however, does not need to completely cover the entire overlap region 8 or the total second surface section 2, but rather can comprise in a smaller surface region, in contrast. In FIG. 1, for example, an end section of the label, without an indicator component, could follow, added to the second surface section 2, which section is just as wide or even wider than the second surface section 2 and also comes to lie on a label section previously pressed onto the ampoule circumference during dispensing; it could carry merely an adhesive layer instead of the indicator material on the underside. Analogously, the label can also extend beyond the first surface section 1 (on the left in FIG. 1), beyond the first indicator component 11. The offset V between the indicator components 11, 12 or the surface sections 1, 2 spanned by them should, however, correspond to the outside circumference of the standardized ampoule or the other container for which the label is designed. The height of an ampoule along the second direction y is also usually standardized.

FIGS. 2 to 5 show cross-sectional views of different embodiments of the overlapping wrap-around label 10 from FIG. 1, which can also be combined with one another. According to FIG. 2, the first indicator component 11 is situated on the top side 10a of the label, for example as a pasty mass 7. The second indicator component 12 is provided underneath the underside 10b at the opposite end in the longitudinal direction (first direction x), which corresponds to the subsequent circumference direction of the dispensed label. The label is adhesively attached to the outside circumference of an ampoule, for example, starting with its first surface section 1, on the underside, until the second indicator component 12, disposed on the underside, comes to lie above and on the first indicator component 11, thereby causing the active indicator material 15 to be formed. Alternatively, the top side of the label can be adhesively attached to the ampoule circumference, starting with the second surface section 2. In FIG. 2, the layer structure of the overlapping wrap-around label 10 is not shown in any detail in direction z; at least one film layer 100 composed of plastic is provided, which is transparent and preferably colorless. An imprinting, optionally also outside of at least one viewing window, can be provided on the top side 10a, above the second surface section 2, over its whole area and, for example, in a white color. The underside 10b can carry an adhesive layer over its whole area or in certain regions. Imprinting and adhesive layer are not shown in FIG. 2.

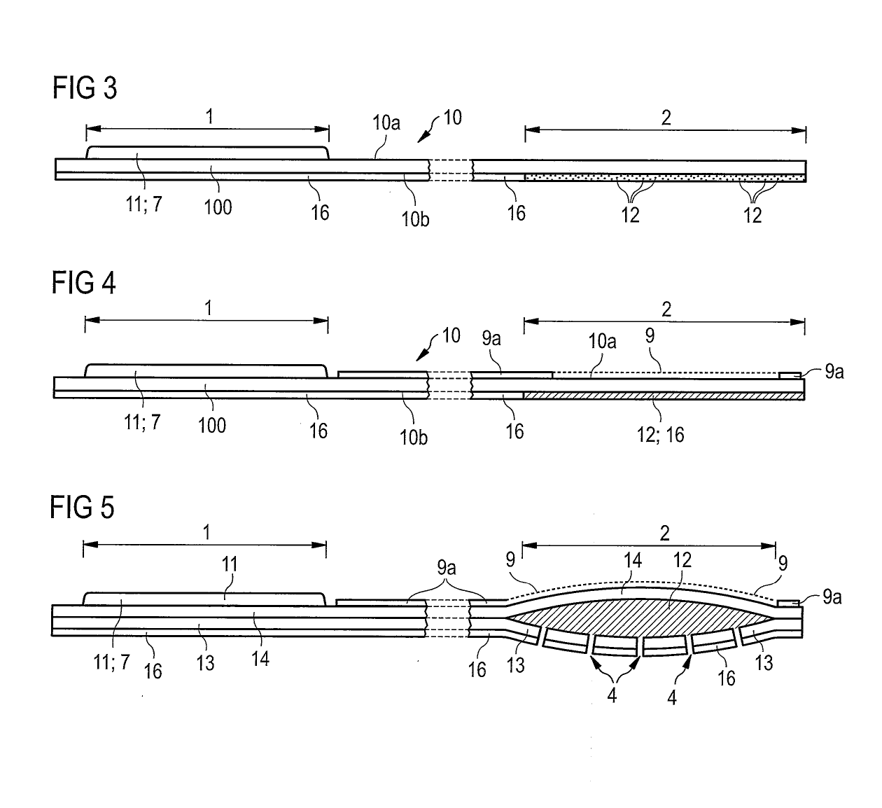

FIG. 3 shows an embodiment having an adhesive layer 16 underneath the underside 10b. The adhesive layer 16 extends both within and outside of the second surface section 2. The second indicator component 12 is contained in the second surface section 2 as an admixture, i.e. as a local, additional ingredient in the material of the adhesive layer 16. Imprinting of the top side 10a is not explicitly shown in FIG. 3.

FIG. 4 shows an embodiment having both an underside adhesive layer 12 and top-side imprinting 9a. In the first surface section 1, at least the first indicator component 11 is not imprinted, i.e. it is exposed. In the second surface section 2, the top side is either completely not imprinted or provided with a viewing window 9, i.e. a recess in an imprinting 9a, in order to subsequently be able to recognize the color tone and/or the brightness of the indicator material that has been formed from the two components, underneath, through the transparent plastic film (film layer 100), on the labeled ampoule. The second surface section 2 can also have multiple partial regions having a layer having the second indicator component 12, in each instance, and a viewing window 9 disposed above it. The labels of FIGS. 2 to 5 can also have a plurality of plastic films or other films or film layers.

FIG. 5 shows a further development in which a chamber 3 or a plurality of chambers 3 is configured between two plastic films, namely a lower film layer 13 and an upper film layer 14, in the second surface section 2, which chamber/chambers is/are filled with the second indicator component 12. The dimensions and proportions in FIG. 5 are only schematic and not to scale. The chamber 3 forms a pocket in the second surface section, within the layer sequence or layer stack of the overlapping wrap-around label 10, which pocket is filled with the second indicator component 12, for example as a viscous or semi-solid mass, in the starting state of the label. It can be pressed out through exit openings 4, during dispensing of the label, toward the label underside 10b, where it comes into contact with the first indicator component of the first surface section 1, applied on the top side, as the label is adhesively attached to the circumference of an ampoule. The press-down pressure applied against the label for dispensing the label, with the circumference of the ampoule or the other article as a counter-bearing, can suffice to empty the chamber 3 or, in any case, to bring sufficient material of the second indicator component 12 into contact with the first indicator component 11. The exit openings 4 can comprise, for example, a plurality of passage openings, at least in the lower film layer 13 and/or an underside adhesive layer 16, for example in the form of punched-out regions, perforations, or incisions. In the region underneath the chamber 3, the perforated or permeable lower film layer 13 is then structured essentially as a membrane.

FIG. 6 shows a further development of the overlapping wrap-around label 10, the second surface section 2 of which is shown enlarged and purely schematically, in a top view of the outside. According to FIG. 6, a plurality of chambers 3 is provided, in which a certain supply of the second indicator component 12 is accommodated, in each instance, as in FIG. 5. The label is slightly curved in convex manner in the region of the chambers 3 (see FIG. 5). Exit openings 4 are provided at least in the lower film layer 13, through which the second indicator component 12 can exit from the chamber 3. According to FIG. 6, channels 6 are furthermore provided in addition to or as an integral part of the exit openings 4, through which the exiting component 12 can flow in the direction −y (opposite to the direction y shown in FIG. 6) of the (laterally offset) surface region in which the first indicator component 11 of the first surface section 1, which has been adhesively attached first and is then situated directly underneath the second surface section 2, is exposed after dispensing of the overlapping wrap-around label 10 onto the article. The outer ends 4a of the channels 6 are situated within the viewing window 9 (recess in the imprinting 9a), in each instance, within the basic surface of the label. There, the indicator material 15 formed after the two indicator components 11, 12 have entered into contact with one another is active, so that when a critical temperature or another parameter is exceeded, a change in color and/or a change in brightness can be observed in the viewing window 9. Optionally, only a single chamber 3 and a single viewing window 9, or, as shown in FIG. 6, a plurality of them can be provided. While the viewing window 9 is configured in the (optional) imprinting, on top of the upper film layer 14, the exit openings 4 and the channels 6 are configured in and/or underneath the lower film layer 13. The channels can also run apart from one another divergently, for example in the form of a fan, instead of parallel to one another. Instead of the channels 6 and exit openings 4, other recesses 5 can also be configured in all or some of the layers underneath the chamber 3, in each instance. The lower film layer 13 or another layer underneath it can also be a membrane that is permeable for the second indicator component 12.

FIG. 7 shows a schematic cross-sectional view of the second surface section 2 from FIG. 6 along the direction y. The chambers 3 filled with the second indicator component 2, between the lower 13 and the upper film layer 14, lead to slight local elevations (shown in exaggeratedly large manner for the sake of clarity, just like the layer thicknesses in FIGS. 7 and 8). FIG. 7, in particular, shows the progression of the channels 6 that run laterally in the direction of the viewing windows 9, under the chambers 3. They are open toward the bottom. The first surface section 1, which is shown in the same cross-sectional view in FIG. 8, lies underneath them in the overlapping wrap-around label 10 that has already been dispensed and overlaps with itself. According to FIG. 7, the exit openings 4 can be configured in the lower film layer 13 and the channels 6 in the adhesive layer 16 and/or in an (optional) layer composed of relief varnish 17, which is disposed between the film layer 13 and the adhesive layer 16, as FIG. 7 shows as a cross-sectional view at the level of one of the channels 6 from FIG. 6. The arrows in FIG. 7 show the path distance that the indicator component 12 pressed out of the chamber 3 moves along on its way through the channel, in each instance, in the direction of the outer ends 4a, in order to reach the first indicator component 12 underneath the viewing window 9 and to form the active indicator material there. Here, the channels 6 are elongated, extended recesses, for example in the layer composed of relief varnish 17 and the adhesive layer 16, the shape of which can be changed in any desired manner. The outer ends 4a of the channels and a partial piece of the channels 6 guided to them can be observed from the outside through the viewing window 9, in each instance.

When the overlapping wrap-around label 10 is dispensed (i.e. rolled off around the circumference of an article), the second surface section 2 shown in cross-section in FIG. 7 comes to lie approximately congruent with the first surface section 1, also shown in cross-section along the direction y in FIG. 8, and covers it. The first surface section 1 from FIG. 8 contains the same layer sequence of adhesive layer 16, lower film layer 13, and upper film layer 14, with the exception of the relief varnish 17. If one places the representations from FIGS. 7 and 8 directly one on top of the other, then a cross-sectional drawing of the overlap region 8 of the two surface sections 1, 2 is formed, in which the adhesive layer 16 lies directly on the first surface section 1, particularly on the first indicator component 11 of the latter, outside of its recesses 5. This occurs by means of the press-down pressure applied during dispensing of the label around the circumference of the article. This pressure, by means of which the label is successively pressed against the outer circumference surface of the article, in the circumference direction (and in direction x), also ensures that the chambers 3 are compressed and thereby the second indicator component 12 is pressed out of them and conveyed into the channels 6 or recesses 5. According to FIG. 8 (in connection with FIG. 7), it can be observed, in the partial region b, which corresponds to the viewing window 9, in each instance, whether the fact that a maximum temperature or another critical parameter change has been exceeded is optically indicated by the indicator, in irreversible manner. However, this is only possible after the second indicator component 12 impinges upon the first indicator component 11 in the partial region b, and the detection-sensitive, active indicator material 15 forms there.

If the label of FIGS. 6 to 8 is adhesively attached around an ampoule vial (vial) for liquid medications, for example, which generally stands upright, then the flow direction of the second indicator component 12 that is pressed out of the chambers 3 along the channels 6 (negative y direction) corresponds to the direction of gravity. By means of metering the volume of the component 12 in the chambers 3 and dimensioning the channels and/or exit openings, the result can be achieved that during dispensing, at first only a section of the channels 6 is filled with the indicator component 12, and the component 12 flows from there into the section of the channels 6 that is visible from the outside, in each instance, with a certain, adjustable time delay. In such an embodiment, the indicator occurs in the viewing window 9 of the overlapping wrap-around label 10 only a certain time after dispensing around the outside circumference of an ampoule vial and its perpendicular storage. In this way, time-delayed activation of the indicator can be implemented. For example, a semi-solid mass can be embedded between two plies 13, 14 of the label as the second indicator component; this mass then runs through the exit openings 4 and the channels 6 (adhesive recesses) or, alternatively, through a membrane, in the direction of the viewing window 9. Fundamentally, the first indicator component 11 only needs to be disposed in the surface region of the viewing windows 9. Furthermore, the label of FIGS. 6 to 8 can be modified to the effect that the channels run along the direction x (instead of y); in contrast to FIG. 6, the viewing windows 9 and the ends 4a of the channels 6 are then situated offset from the chambers 3 in the x direction, i.e. close to the second end of the overlapping wrap-around label.

FIG. 9 shows an alternative embodiment to FIG. 2, in which the two indicator components 11, 12 are disposed on the underside 10b of the label or its film layer 100. The component, in each instance, can be present as a paste 7, for example, as a first indicator component 11, or as an admixture to an adhesive layer 16.

FIG. 10 schematically shows an article 50, for example a container 70 (particularly for a medication, another pharmaceutical product, a liquid or a food) in cross-section perpendicular to the circumference 55 or to the circumference surface 60, which has an overlapping wrap-around label 10 (according to one of FIGS. 1 to 8) adhesively attached around it. In the overlap region 8, where the second surface section 2 covers the first 1 (or vice versa), the first indicator component 11 of the first surface section 1, disposed on the top side, comes into direct contact with the second indicator component 12 disposed on the underside of the second surface section 2, for example, thereby causing the active, detection-sensitive indicator material 15 to be formed only during dispensing of the label, at least at the boundary surface between the two components 11, 12. Possible discolorations or changes in brightness of the indicator material 15 can be observed through the viewing window 9 of the outer imprinting 9a. Along the circumference direction u, which corresponds to the first direction x of FIGS. 1 to 8, the overlapping wrap-around label 10 was rolled onto or adhesively attached to and pressed against the ampoule or other container 70 from FIG. 10, in a counterclockwise direction.

FIG. 11 analogously shows an article 50 that has an overlapping wrap-around label 10, but one according to FIG. 9, adhesively attached around it. In contrast to FIG. 10, the first 1 and the second surface section 2 are adhesively attached to one another with their back sides, and thereby form an upright pennant 18 or one that can be set upright. The pennant 18 contains the indicator material 15 formed from the two indicator components 11, 12 that stand in contact with one another, which material is now able to indicate critical changes in temperature or parameter by means of color.

FIG. 12 shows a label arrangement 20 having a label backing web 25 as well as at least a first partial label 30 and a second partial label 40, which are releasably adhesively attached to the label backing web 25 and adhere to it. The two partial labels 30, 40 are coordinated with one another, in terms of their structure and their placement relative to one another, in such a manner that they can be adhesively attached to the circumference of an article, particularly a container (such as, for example, that from FIG. 10 or 11), one after the other, by means of simple unrolling, and, in this connection, can be connected, at the same time, to form a total label that has an indicator that occurs and becomes detection-sensitive only as the result of dispensing the two partial labels 30, 40 one on top of the other. The label backing web 25 is preferably configured as a backing roll having a plurality of first and second partial labels 30, 40, in an alternating sequence. In FIG. 12, the backing web 25 therefore continues to run toward both sides along the first direction x. The first or second partial label 30, 40, in each instance, possesses a first or second surface section 1, 2, in each instance, in which the first or second indicator component 11, 12, respectively, is disposed. Furthermore, one or both labels can also have surface regions that are not covered or underlaid with material of the indicator components. In FIG. 12, the second partial label 40 or its film layer 41 is approximately the same size as the second surface section 2 having the second indicator component 12. The latter is disposed, for example, on the underside of the film layer 41, as indicated by the broken lines. In the first surface section 1 of the first partial label 30, in contrast, the first indicator component 11 is situated on the top side of the first partial label 30 or on its film layer 31. Laterally on both sides of the first surface section 1, the first partial label 30 furthermore possesses extensive surface sections without any indicator component. The width of the two surface sections 1, 2 provided with indicator components 11, 12 is preferably identical in the two partial labels 30, 40, thereby defining an overlap region 8. A lateral offset V exists between the two indicator components 11, 12, along the direction x of the label backing web 25, which offset in turn corresponds to the circumference of the standardized ampoule vial (vial) or other article to be labeled. The distance d between the edges of the two partial labels 30, 40 that face one another, on the label backing web, as well as the dimensions of the two partial labels in the x direction, are dimensioned in such a manner that the distance between those outer edges of the indicator components 11, 12 that face away, in each instance, from the other indicator component, in each instance, once again corresponds to the length L of a corresponding one-part label from FIG. 1. In contrast to FIG. 1, however, the total label is formed from the label arrangement 20 only when the two partial labels 30, 40 have been transferred from the label backing web 25 to the circumference surface 60 of a container or other article, one after the other. In this connection, the two partial labels 30, 40 come into contact with one another for the first time, and come to lie, relative to one another, in such a way that the second surface section 2 having the second indicator component (of the second partial label) covers the first surface section having the first indicator component (of the first partial label 30) (or vice versa). In the case of the total label formed in this way, as well, the detection-sensitive indicator material 15 is only formed from the two indicator components 11, 12 during dispensing. The label backing web 25 can be discarded; it serves only for precise positioning of the two partial labels relative to one another.

FIG. 13 shows, in a schematic partial view, the layer sequence of the total label 45 formed in this way, over a small section of the circumference of the article (which is therefore shown without any curvature). The layer structure is shown in the viewing window (i.e. without outer imprinting). According to FIG. 13, first the first partial label 30 was adhesively attached to the circumference 55 or the circumference surface 60 of the container 70 or other article 50 with its film layer 31 and the first indicator component 11 disposed on its top side. Afterward, after having passed once around the article during labeling, the second partial label with its film layer 41 and its second indicator component 12 on the underside comes to lie on top of the first, thereby causing the active indicator 15 to form at least at the boundary surface between the two indicator components 11, 12. In the case of top-side imprinting of the second partial label 40, a viewing window is left open in it, above the indicator 15.

FIG. 14 shows an alternative embodiment of the total label 45, which was formed in that first the second partial label 40 from FIG. 12 and only then the first partial label 30 from FIG. 12 was adhesively attached. As a result, the indicator component 11 and the film layer 31 of the first partial label 30 come to lie above those 12, 41 of the second partial label 40. For such a total label 45, in FIG. 12 the first indicator component 11 can be disposed underneath the film layer 31 of the first partial label 30 (i.e. directly on the label backing web 25), and the second indicator component 12 of the second partial label 40, in contrast, can be disposed above the film layer 41.

The vertical positioning of the indicator components, in each instance, above and below the film layers or partial labels, in each instance, can also be selected vice versa, in each instance, for example if the two partial labels are supposed to be pressed directly onto the outside circumference of the container or other article with their top side.

A further exemplary embodiment for a label having a first and a second indicator component, which form an indicator arrangement only after they have been brought together, is shown in FIG. 15, with modifications of this in FIGS. 16 and 17. The cross-sectional views shown are not to scale. In particular, the layer stacks applied to the label substrate are not shown true to scale, and serve to explain the basic structure of the label. The label 150 in FIG. 15 contains the second indicator component 152 on its underside, which component can be applied to the label over part of the area or even over the full area. The first indicator component 151, which can also be applied over part of the area or over the full area, is situated on the top side. The first indicator component can be adhesively attached or also applied as a hot-embossing film. On the underside, an adhesive layer 155 is also present, in addition to the second indicator component, so that the label serves as a self-adhesive label. The adhesive layer 155 can also be eliminated in embodiments.

A coating layer 153 can be situated between the first indicator component 151 and the label substrate 150, or, in addition, also lettering that makes a time-dependent and/or temperature-dependent change in the first indicator component 151 after contacting with the second indicator component 152 better observable and increases the contrast, after the first indicator component has been corrosively decomposed.

Furthermore, a barrier layer 154 can be situated on the top side of the first indicator component 151, which layer influences the time-dependent and/or temperature-dependent reaction with the second indicator component after contacting. Such barrier layers for time indicators and/or temperature indicators are described, for example, in WO 91/06853. For example, the beginning and time progression of the reaction of the two indicator components can be controlled relatively precisely by means of the selection and the thickness of the material for the barrier layer. Commercially available polymer films metallized with aluminum, or also polymers, for example, can be used as barrier layers. The barrier layers are dissolved by means of pitting corrosion, as described in WO 91/06853, or become permeable, so that afterward, the first and second indicator components enter into contact with one another. Thereby the beginning of entry into contact between the first and second indicator components can also be controlled in terms of time.

As shown in FIG. 16, the adhesive layer 165 can also be structured as a doped polymer layer having the second indicator component. The second indicator component is therefore mixed with the adhesive layer over a greater surface area. The layer stack in the region of the first indicator component corresponds to the arrangement in FIG. 15.

In FIG. 17, an adhesive layer 176 and a backing film for the metal layer of the first indicator component are additionally disposed between the coating layer 173 and the first indicator component 171, which can be a metal layer.

In FIGS. 15 to 17, the first and the second indicator components can be structured as follows. The first indicator component 151, 171 can be a metal layer or a layer containing metal or a metallized film layer, preferably composed of a polymer film. The metal can be one of the metals aluminum, copper, silver, iron, magnesium, tin, chromium, zinc, nickel, titanium or an alloy of these aforementioned metals.

The thickness of the metal layer amounts to 1 nm to 1 mm, preferably 5 nm to 0.5 mm.

The second indicator component 152, 172 can be a doped polymer layer, whereby the doping substance is an acid, a base or a salt. The polymer can also be functionalized with an acidic or basic group, or functionalized with latently acidic or basic groups, for example with photolatent acids or photolatent bases, which release the acid or base when irradiated with light.

The polymer is the carrier for the doping substance and can be a homopolymer, copolymer, adhesive or a viscoelastic liquid. The polymer consists, for example, of polyethyleneimine, polyethylene glycol, polysulfonate, polyacrylate, polymethacrylate, polyvinyl alcohol, polyvinyl chloride, polyolefin, latex, or contains one or more of these substances.

The doping substance can be a salt, for example an alkali or earth alkali metal halogenide, alkali or earth alkali metal sulfate, alkali or earth alkali metal carbonate or also an alkali or earth alkali metal nitrate. The doing substance can also, as an alternative to the aforementioned substances, be an acid, for example phosphoric acid, nitric acid, hydrochloric acid, sulfuric acid, polyphosphoric acid, phosphonic acid. The doping substance can also be a base, such as, for example, an alkali or earth alkali metal hydroxide or ammonium hydroxide. Photolatent acids are, for example, ESACURE® (Lamberti), IRGACURE® PAG 103 (Ciba) or UVI® (Dow). IRGACURE® 369 or IRGACURE® 907 from Ciba can be used as photolatent bases, for example. These substances explained in connection with FIGS. 15 to 17 are known, as described, for example, in WO 2008/083926.

Activation of the time indicator and/or temperature indicator takes place by means of contacting of the first indicator component 151, 171 with the second indicator component 152 or 172 over the full area. After contacting, a chemical reaction of the two reaction components with one another takes place. For example, according to one embodiment, the shiny metal layer of the first indicator component is dissolved, in time-dependent and/or temperature-dependent manner, by the acid of the second indicator component, something that is recorded, in terms of measurement technology, by means of detection of the changing optical (absorption, transmission, reflection) or electrical (resistance) properties, but also can be seen visually, with the naked eye, without additional aids.

In an alternative embodiment, the two indicator components can already be present combined with one another. In this connection, a polymer layer functionalized with latently acidic or latently basic groups contains metal particles. The latent acids and bases can be photolatent, whereby the acids or bases are released upon irradiation with light. Activation of the indicator therefore takes place by means of irradiation with light.

1. Overlapping wrap-around label for being adhesively attached around the circumference of an article, wherein the overlapping wrap-around label has a first indicator component and a second indicator component that form an indicator arrangement by being brought into contact with one another,
wherein the first indicator component is disposed in a first surface section of the basic surface of the overlapping wrap-around label and the second indicator component is disposed in a second surface section of the basic surface of the overlapping wrap-around label, and
wherein the second surface section is offset, relative to the first surface section, along a first direction, and thereby disposed separately from the first indicator component.

2. Overlapping wrap-around label according to claim 1,
wherein
the second surface section having the second indicator component is disposed offset, along a first direction, relative to the first surface section having the first indicator component, to such an extent that when the overlapping wrap-around label is dispensed, the second surface section comes to lie on the first surface section and/or laterally directly adjacent above the first surface section.

3. Overlapping wrap-around label according to claim 1,
wherein
a lateral offset between the second surface section and the first surface section along the first direction relative to the total length of the overlapping wrap-around label along the first direction is dimensioned in such a manner that when the overlapping wrap-around label is dispensed, the second indicator component comes to lie congruently on the first indicator component.

4. Overlapping wrap-around label according to claim 1,
wherein
the first indicator component is disposed on the top side of the overlapping wrap-around label, but the second indicator component is disposed on the underside of the overlapping wrap-around label, or vice versa.

5. Overlapping wrap-around label according to claim 1,
wherein an indicator material is formed by bringing the first indicator component and the second indicator component into contact with one another.

6. Overlapping wrap-around label according to claim 1,
wherein
the first indicator component is disposed on the top side of the overlapping wrap-around label, whereas the second indicator component is disposed in the interior of the overlapping wrap-around label, in a chamber or in a plurality of chambers, which are connected with the underside of the overlapping wrap-around label by means of at least one exit opening.

7. Overlapping wrap-around label according to claim 6,
wherein
the overlapping wrap-around label has at least two film layers that lie one on top of the other, comprising a lower film layer and an upper film layer, wherein the second surface section comprises at least one chamber filled with the second indicator component, which is formed between the lower film layer and the upper film layer.

8. Overlapping wrap-around label according to claim 6,
wherein
the at least one exit opening comprises recesses, for example punched-out regions, which are formed in the lower film layer in a relief varnish and/or in a lower adhesive layer underneath the lower film layer.

9. Overlapping wrap-around label according to claim 6,
wherein
the at least one exit opening comprises one or more channels that run in the overlapping wrap-around label, through which the second indicator component can be pressed out of the chamber or plurality of chambers, and can be conveyed into a label section of the overlapping wrap-around label that is laterally offset relative to this, which section is provided for covering the first indicator component.

10. Overlapping wrap-around label according to claim 6,
wherein
the chamber or plurality of chambers filled with the second indicator component possesses an additional lateral offset along a second direction which faces perpendicular to the first direction, relative to the first indicator component, and wherein the exit openings lead to a label section on the underside of the overlapping wrap-around label, which comes to lie directly on the first surface section during dispensing of the overlapping wrap-around label.

11. Overlapping wrap-around label according to claim 1,
wherein
the first and the second indicator component are disposed on two ends of the overlapping wrap-around label that lie opposite one another, on the underside of the overlapping wrap-around label and/or in a chamber or a plurality of chambers disposed in the overlapping wrap-around label, which has exit openings toward the underside,
wherein the first surface section and the second surface section are configured in such a manner that they can be joined together during dispensing of the overlapping wrap-around label, by means of back-side adhesive attachment, to form an upright pennant or one that can be set upright, which has an indicator material formed from the two indicator components.

12. Overlapping wrap-around label according to claim 1,
wherein
the first indicator component and the second indicator component are selected in such a manner that they result in an indicator material when brought into contact with one another, which material optically indicates that a maximum temperature has been exceeded, that a minimum temperature has been fallen short of or that UV radiation has impacted, in irreversible manner.

13. Overlapping wrap-around label according to claim 1,
wherein
a coating layer is disposed between a substrate of the label and the first indicator component.

14. Overlapping wrap-around label according to claim 1,
wherein
the first indicator component is a metal layer or a layer containing metal or a metallized film layer.

15. Overlapping wrap-around label according to claim 1,
wherein
the second indicator component is a polymer layer doped with a doping substance, wherein the doping substance is an acid or a base or a salt or a photolatent acid or a photolatent base.

16. Overlapping wrap-around label according to claim 1,
wherein
the second indicator component is a polymer layer, wherein the polymer is functionalized with an acidic or latently acidic or a basic or latently basic group or such groups.

17. Overlapping wrap-around label according to claim 1,
wherein
a barrier layer is disposed above the first indicator component, which layer controls the beginning of bringing the first and the second indicator component into contact, in terms of time.

18. Overlapping wrap-around label according to claim 1,
wherein
the overlapping wrap-around label has one or more transparent, preferably colorless film layers composed of plastic, and wherein the overlapping wrap-around label is not imprinted in the surface region above the second component or provided with a viewing window configured as a recess in an imprinting.

19. Overlapping wrap-around label according to claim 1,
wherein
the first indicator component of the first surface section is a pasty mass on the top side of the overlapping wrap-around label, whereas the second indicator component of the second surface section is contained in an adhesive layer on the underside of the overlapping wrap-around label.

20. Article, particularly a container for a medication, for another pharmaceutical product, for a liquid or for a food,
wherein the circumference of the article has an overlapping wrap-around label according to claim 1 adhesively attached around it,
wherein the overlapping wrap-around label wraps completely around the circumference of the article and overlaps with itself, thereby forming an overlap region in which a second surface section of the overlapping wrap-around label, having a second indicator component, lies on a first surface section of the overlapping wrap-around label, having a first indicator component,
wherein an indicator arrangement formed from two indicator components that stand in contact with one another is formed in the overlap region.

21. Article, particularly a container for a medication, for another pharmaceutical product, for a liquid or for a food,
wherein the circumference of the article has an overlapping wrap-around label according to claim 11 adhesively attached around it,
wherein the overlapping wrap-around label wraps completely around the circumference of the article and has a pennant that is set upright or can be set upright from the article, which pennant is formed from two opposite, end-side surface sections, which are adhesively attached to one another with their undersides, and have an indicator component, in each instance, and
wherein the pennant has an indicator arrangement formed from two indicator components that stand in contact with one another.

22. Label arrangement for labeling the circumference of an article using two partial labels, one on top of the other, wherein the label arrangement comprises at least one label backing web as well as a first partial label and a second partial label, which are releasably adhesively attached to the label backing web,
wherein the first partial label has a first surface section having a first indicator component, and wherein the second partial label has a second surface section having a second indicator component, from which an indicator arrangement is formed by means of bringing it into contact with the first indicator component,
wherein the first and the second partial label are adhesively attached along a first direction of the label backing web, at a distance from one another,
wherein the position of the first and second surface section along the first direction and/or the distance between the two partial labels is dimensioned in such a manner that the second indicator component is offset along the first direction, relative to the first indicator component, by a distance that corresponds to the predetermined circumference of the article.

23. Label arrangement according to claim 22,
wherein
the second surface section of the second partial label possesses the same width, along the first direction, as the first surface section of the first partial label, and is spaced apart from the first surface section to such an extent that the second indicator component of the second partial label comes to lie congruently on or under the first indicator component of the first partial label when the two partial labels are dispensed onto the circumference of an article.

24. Label arrangement according to claim 22,
wherein
a plurality of first partial labels that have a first surface section having a first indicator component and of second partial labels that have a second surface section having another, second indicator component are disposed on the label backing web in an alternating sequence,
wherein a first partial label and a second partial label directly adjacent to the former are adhesively attached to the label backing web in such a manner that they can be joined together to form a total label, which contains an indicator arrangement formed from the two indicator components, by means of being rolled off the label backing web, one after the other, and adhesively attached to the circumference of an article.

25. Label arrangement according to claim 22,
wherein
in the direction perpendicular to the label backing web, the second indicator component is disposed on the second partial label on the opposite surface from the first indicator component on the first partial label.

26. Method for labeling the circumference of an article, particularly of a container for a medication, for another pharmaceutical product, for a liquid or for a food,
wherein a label arrangement is used that comprises a label backing web as well as at least a first partial label and a second partial label, which are releasably adhesively attached to the label backing web at a distance from one another, wherein the first partial label has a first surface section having a first indicator component, and the second partial label has a second surface section having a second indicator component,
wherein the first partial label and the second partial label are released from the label backing web one after the other and adhesively attached to the circumference of the article, in such a manner that the two partial labels come to lie one on top of the other on the circumference of the article in a position such that the first indicator component of the first surface section of the first partial label comes into contact with the second indicator component of the second surface section of the second partial label, and thereby an indicator arrangement is formed from the two indicator components.
